(19) United States
(12) Patent Application Publication
(10) Pub. No.: US 2003/0059162 A1
(43) Pub. Date: Mar. 27, 2003

(54) Optical collimator for a WDM unit

(76) Inventors: Yu-Wen Hwang, Hsinchu (TW); Chung-I Lin, Kaohsiung (TW)

Correspondence Address: BIRCH STEWART KOLASCH & BIRCH, PO BOX 747, FALLS CHURCH, VA, 22040-0747, US

(21) Appl. No.: 10/247,544

(22) Filed: Sep. 20, 2002

(30) Foreign Application Priority Data
Sep. 26, 2001 (TW) 90123717

(51) Int. Cl. G02B 6/32

(52) U.S. Cl. 385/34

(57) ABSTRACT

An optical collimator for WDM application. Preventing the adhesive material from blocking the light path, the optical collimator includes a glass ferrule with a hole, at least one optical fiber grasped by the glass ferrule, a GRIN lens having two end surfaces, with one end surface of the GRIN lens combined with the glass ferrule, and a filter combined with another end surface of the GRIN lens. At least one pad with an opening is sandwiched between the filter and the GRIN lens, and, using a thermal-curing epoxy, the pad adheres to the GRIN lens and the filter adheres to the pad.

### BACKGROUND OF THE INVENTION

1. Field of the Invention

The invention relates to an optical collimator, and more particularly to an optical collimator for a WDM unit.

2. Description of the Related Art

FIG. 1 schematically shows a cross-section of a conventional optical collimator. As shown in FIG. 1, the conventional optical collimator 1 for WDM application has a glass ferrule 2, an optical fiber 3, a GRIN lens 4 and a filter 5. The glass ferrule 2 has a hole 2a, and grasps the optical fiber 3 through the hole 2a. Next, the end surface 2b of the glass ferrule 2 is combined with the end surface 4a of the GRIN lens 4 by applying a UV-curing epoxy 6 to their edges, and the filter 5 adheres to another end surface 4b of the GRIN lens 4 using a thermal-curing epoxy 7.

However, the UV-curing epoxy 6 for combining the glass ferrule 2 with the GRIN lens 4 deteriorates under the wet conditions. If the thermal-curing epoxy 7 replaces the UV-curing epoxy 6, the time for curing the thermal epoxy applied to the edges of the glass ferrule and the GRIN lens becomes longer. Additionally, the thermal-curing epoxy 7 melts during heat-curing, and permeates the gap 9 between the glass ferrule 2 and the GRIN lens 4. Thus, the thermal-curing epoxy 7 blocks the light path and reduces the light intensity.

FIG. 2 schematically shows a cross-section of another conventional optical collimator. As shown in FIG. 2, another conventional optical collimator 11 for WDM application has a glass ferrule 12, an optical fiber 13, a GRIN lens 14, a first tube 18a, a second tube 18b and a filter 15. The glass ferrule 12 has a hole 12a grasping the optical fiber 13, and is then positioned in the first tube 18a. The GRIN lens 14 is positioned in the second tube 18b, and aligns with the glass ferrule 12. After obtaining optimum collimated beam from the GRIN lens 14, the first tube 18a is combined with the second tube 18b by applying a thermal-curing epoxy 17. Furthermore, the thermal-curing epoxy 17 is permeated between the glass ferrule 12 and the inner sidewall of the first tube 18a, and permeated between the GRIN lens 14 and the inner sidewall of the second tube 18b by capillarity.

The conventional optical collimator 11 uses the thermal-curing epoxy to combine the optical parts, and has a better ability to resist the wet conditions. However, the thermal-curing epoxy 17 easily permeates the gap between the glass ferrule and the GRIN lens, and has the same disadvantages of blocking the light path and reducing the light intensity.

### SUMMARY OF THE INVENTION

To solve the above problems, it is an object of the present invention to provide an optical collimator for a WDM unit, which includes a ringlike pad with an opening. The filter and the GRIN lens are respectively adhered to each side surface of the ring-like pad using an adhesive material.

Another object of the invention is to provide an optical collimator for a WDM unit, wherein, using the adhesive material, the glass ferrule and the GRIN lens are respectively adhered to each side surface of the first ringlike pad, and the filter and the GRIN lens are respectively adhered to each side surface of the second ringlike pad.

A feature of the invention is that the ringlike pad is sandwiched between the GRIN lens and the filter, and using the adhesive material, the filter is adhered to one side surface of the ringlike pad and the GRIN lens is adhered to another side surface of the ringlike pad.

Another feature of the invention is that another ring-like pad is sandwiched between the glass ferrule and the GRIN lens, and using the adhesive material, the glass ferrule is adhered to one side surface of the ringlike pad and the GRIN lens is adhered to another side surface of the ringlike pad.

### BRIEF DESCRIPTION OF THE DRAWINGS

This and other objects and features of the invention will become clear from the following description, taken in conjunction with the preferred embodiments with reference to the drawings, in which:

FIG. 1 schematically shows a cross-section of a conventional optical collimator;

FIG. 2 schematically shows a cross-section of another conventional optical collimator;

FIG. 3 schematically shows a cross-section of an optical collimator for WDM application according to the first embodiment of the invention;

FIG. 4 schematically shows a cross-section of an optical collimator for WDM application according to the second embodiment of the invention;

FIG. 5 schematically shows a cross-section of an optical collimator for WDM application according to the third embodiment of the invention;

FIG. 6 schematically shows a ringlike pad applied to the optical collimator of the invention; and

FIG. 7 schematically shows various shapes of the ring-like pad applied to the optical collimator of the invention.

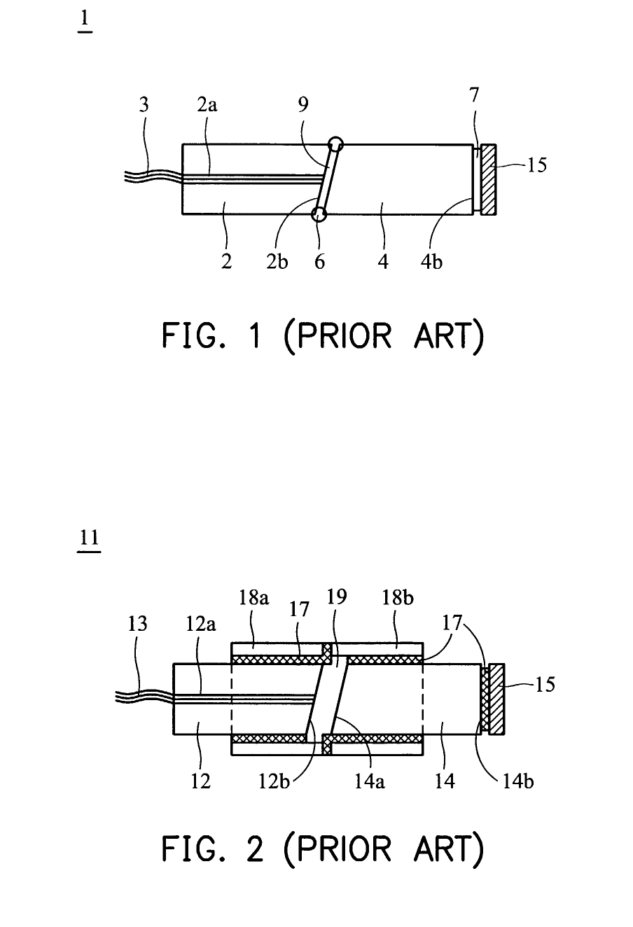

### DETAILED DESCRIPTION OF THE INVENTION

First Embodiment

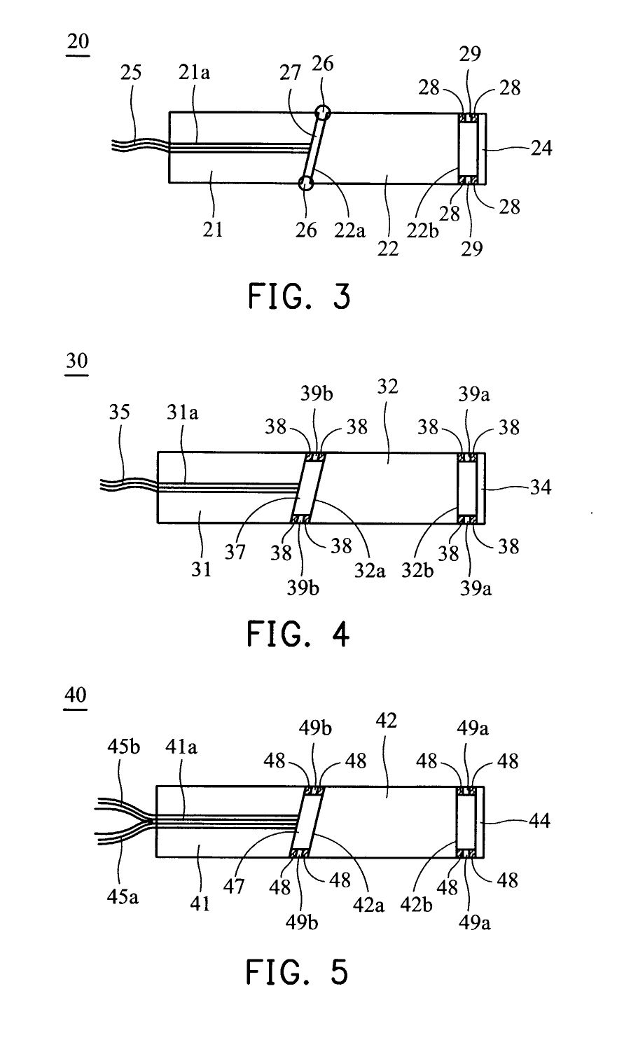

FIG. 3 schematically shows a cross-section of an optical collimator for WDM application according to the first embodiment of the invention. As shown in FIG. 3, the optical collimator 20 of the first embodiment includes a glass ferrule 21, a GRIN lens 22, a ringlike pad 23, and a filter 24. The glass ferrule 21 has a hole 21a grasping an optical fiber 25. The glass ferrule 21 is combined with one end surface 22a of the GRIN lens 22 using a UV-curing epoxy 26. A gap 27 of predetermined size between the glass ferrule 21 and the GRIN lens 22 is formed by applying the UV-curing epoxy 26 to their edges.

Next, the ringlet pad 29 is adhered to another end surface 22b of the GRIN lens 22 by applying a thermal-curing epoxy 28 therebetween. The filter 24 is adhered to the ringlike pad 29 by applying the thermal-curing epoxy 28 therebetween. Thus, the ringlike pad 29 is sandwiched and fixed between the GRIN lens 22 and the filter 24. In the first embodiment of the invention, the thickness of the ringlike pad is 0.18 mm, the outer diameter of the ringlike pad is 0.18 mm, and the inner diameter of the ring-like pad is 0.12 mm. By capillarity, the thermal-curing epoxy is uniformly localized between the ringlike pad and the GRIN lens, and between the ringlike pad and the filter. Accordingly, the first embodiment ensures that the thermal-curing epoxy cannot block the light path.

Second Embodiment

FIG. 4 schematically shows a cross-section of an optical collimator for WDM application according to the second embodiment of the invention. As shown in FIG. 4, the optical collimator 30 of the second embodiment includes a glass ferrule 31, a GRIN lens 32, a first ringlike pad 39a, a second ringlike pad 39b, and a filter 34. The glass ferrule 31 has a hole 31a grasping an optical fiber 35.

The second ringlet pad 39b is adhered to one end surface 32a of the GRIN lens 32 by applying a thermal-curing epoxy 38 therebetween. The glass ferrule 31 grasping the optical fiber 35 is adhered to the second ringlike pad 39b by applying the thermal-curing epoxy 38 therebetween. The first ringlet pad 39a is adhered to another end surface 32b of the GRIN lens 32 by applying the thermal-curing epoxy 38 therebetween. The filter 34 is adhered to the first ringlike pad 39a by applying the thermal-curing epoxy 38 therebetween. Thus, the first ring-like pad 39a is sandwiched and fixed between the GRIN lens 32 and the filter 34. Using the second ringlike pad 39b, a gap 37 of predetermined size between the glass ferrule 31 and the GRIN lens 32 is also formed.

In the second embodiment of the invention, the thickness of the ringlike pad is 0.18 mm, the outer diameter of the ring-like pad is 0.18 mm, and the inner diameter of the ringlike pad is 0.12 mm. By capillarity, the thermal-curing epoxy is uniformly localized between the second ringlike pad and the GRIN lens, and between the second ringlike pad and the filter. Additionally, the thermal-curing epoxy is uniformly localized between the first ringlike pad and the GRIN lens, and between the first ring-like pad and the glass ferrule. Accordingly, the second embodiment ensures that the thermal-curing epoxy cannot block the light path.

Third Embodiment

FIG. 5 schematically shows a cross-section of an optical collimator for WDM application according to the third embodiment of the invention. As shown in FIG. 5, the optical collimator 40 of the third embodiment includes a glass ferrule 41, a GRIN lens 42, a first ringlike pad 49a, a second ringlike pad 49b, and a filter 44. The glass ferrule 41 has a hole 41a grasping a first optical fiber 45a and a second optical fiber 45b.

The second ringlet pad 49b is adhered to one end surface 42a of the GRIN lens 42 by applying a thermal-curing epoxy 48 therebetween. The glass ferrule 41 grasping the two optical fibers 45a, 45b is adhered to the second ringlike pad 49b by applying the thermal-curing epoxy 48 therebetween. The first ringlet pad 49a is adhered to another end surface 42b of the GRIN lens 42 by applying the thermal-curing epoxy 48 therebetween. The filter 44 is adhered to the first ringlike pad 49a by applying the thermal-curing epoxy 48 therebetween. Thus, the first ringlike pad 49a is sandwiched and fixed between the GRIN lens 42 and the filter 44. Using the second ringlike pad 49b, a gap 47 of predetermined size between the glass ferrule 41 and the GRIN lens 42 is also formed.

Before the thermal-curing epoxy localized between the GRIN lens and the glass ferrule is cured, the optical collimator mentioned above is adjusted by a mechanism (not shown). The GRIN lens is positioned on a fixing frame, and the glass ferrule is adjusted by a five motions controller. A beam with wide band is transmitted in the first optical fiber 45a, and enters the GRIN lens. After emitting the beam with wide band from the GRIN lens, the beam is incident on the filter and the filter reflects predetermined wavelength of the beam. Next, the reflected light passes the GRIN lens again, and enters the second optical fiber. When the second optical fiber outputs an optimum signal, the five motions controller stops adjusting the GRIN lens. Finally, the thermal-curing epoxy between the glass ferrule and the GRIN lens is cured, and the glass ferrule, the ringlike pad and the GRIN lens are tightly combined.

In the third embodiment of the invention, the thickness of the ringlike pad is 0.18 mm, the outer diameter of the ring-like pad is 0.18 mm, and the inner diameter of the ringlike pad is 0.12 mm. By capillarity, the thermal-curing epoxy is uniformly localized between the second ringlike pad and the GRIN lens, and between the second ringlike pad and the filter. Additionally, the thermal-curing epoxy is uniformly localized between the first ringlike pad and the GRIN lens, and between the first ring-like pad and the glass ferrule. Accordingly, the third embodiment ensures that the thermal-curing epoxy cannot block the light path.

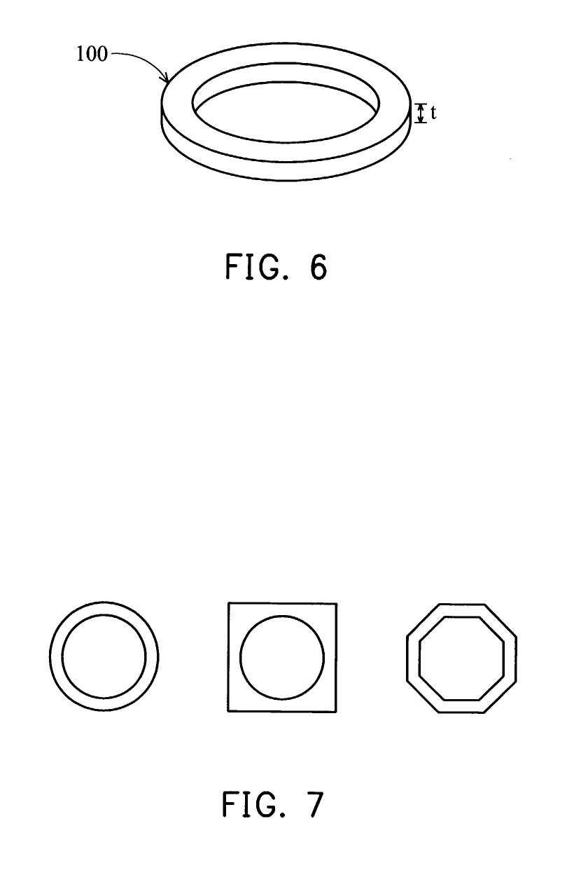

FIG. 6 schematically shows a ringlike pad applied to the optical collimator of the invention. As shown in FIG. 6, the thickness of the ringlike pad 100 is variable so as to obtain minimum insertion loss. FIG. 7 schematically shows various shape of the ringlike pad applied to the optical collimator of the invention. As shown in FIG. 7, the shape of the pad is cylindrical, rectangular or polygonal, and the pad has an opening at its center.

In the invention, the pad is made of the metal, glass, or immalleable material capable of sustaining 200 degrees centigrade.

In the invention, the capillarity results from the liquid in the two adjacent planes. When the thermal-curing epoxy is heated and becomes fluid, the thermal-curing epoxy is uniformly localized between the pad and the optical part adhered to the pad. Thus, the thermal-curing epoxy cannot appear in the opening of the pad, and block the light path. Moreover, because of the capillarity, the pad is tightly sandwiched between the filter and the GRIN lens and the invention increases the adhesion. The capillarity poses a benefit and not a disadvantage.

While the preferred embodiment of the present invention has been described, it is to be understood that modifications will be apparent to those skilled in the art without departing from the spirit of the invention. The scope of the invention, therefore, is to be determined solely by the following claims.

What is claimed is:

1. An optical collimator for WDM application comprising:
a glass ferrule having a hole;
an optical fiber grasped by the glass ferrule;
a GRIN lens combined with the glass ferrule, wherein a predetermined size is formed between the GRIN lens and the glass ferrule;
a first pad with an opening, which adheres to the GRIN lens; and
a filter adhering to the first pad,
wherein the first pad is sandwiched between the filter and the GRIN lens.

2. An optical collimator for WDM application as claimed in claim 1, wherein, using a thermal-curing epoxy, the first pad adheres to the GRIN lens and the filter adheres to the first pad.

3. An optical collimator for WDM application as claimed in claim 1, wherein, by applying a UV-curing epoxy on both edges of the glass ferrule and the GRIN lens, the glass ferrule is combined with the GRIN lens.

4. An optical collimator for WDM application as claimed in claim 1, further comprising a second pad with an opening, sandwiched between the glass ferrule and the GRIN lens.

5. An optical collimator for WDM application as claimed in claim 4, wherein, using a thermal-curing epoxy, the second pad adheres to the glass ferrule and the GRIN lens adheres to the second pad.

6. An optical collimator for WDM application as claimed in claim 1, wherein the shape of the pad is cylindrical, rectangular or polygonal.

7. An optical collimator for WDM application as claimed in claim 1, wherein the material of the pad is metal, glass, or immalleable material capable of sustaining 200 degrees centigrade.

8. An optical collimator for WDM application comprising:
a glass ferrule having a hole;
at least one optical fiber grasped by the glass ferrule;
a GRIN lens combined with the glass ferrule, wherein a predetermined size is formed between the GRIN lens and the glass ferrule; and
a filter combined with the GRIN lens;
wherein the invention is characterized further comprising:
a first pad with an opening, sandwiched between the GRIN lens and the filter; and
a second pad with an opening, sandwiched between the glass ferrule and the GRIN lens.

9. An optical collimator for WDM application as claimed in claim 8, wherein, using a thermal-curing epoxy, the first pad adheres to the GRIN lens and the filter adheres to the first pad.

10. An optical collimator for WDM application as claimed in claim 8, wherein, using a thermal-curing epoxy, the second pad adheres to the glass ferrule and the GRIN lens adheres to the second pad.

11. An optical collimator for WDM application as claimed in claim 8, wherein the shape of the first pad is cylindrical, rectangular or polygonal.

12. An optical collimator for WDM application as claimed in claim 8, wherein the material of the first pad is metal, glass, or immalleable material capable of sustaining 200 degrees centigrade.

13. An optical collimator for WDM application as claimed in claim 8, wherein the shape of the second pad is cylindrical, rectangular or polygonal.

14. An optical collimator for WDM application as claimed in claim 8, wherein the material of the second pad is metal, glass, or immalleable material capable of sustaining 200 degrees centigrade.
